(19) United States
(12) Patent Application Publication
(10) Pub. No.: US 2023/0074366 A1
(43) Pub. Date: Mar. 9, 2023

(54) INFORMATION MANAGEMENT DEVICE, INFORMATION MANAGEMENT SYSTEM, INFORMATION MANAGEMENT METHOD, AND NONTRANSITORY COMPUTER-READABLE MEDIUM

(71) Applicant: NEC Corporation, Minato-ku, Tokyo (JP)

(72) Inventor: Yasuhisa UEFUJI, Tokyo (JP)

(73) Assignee: NEC Corporation, Minato-ku, Tokyo (JP)

(21) Appl. No.: 17/799,730

(22) PCT Filed: Mar. 6, 2020
(86) PCT No.: PCT/JP2020/009585

§ 371 Date: Aug. 15, 2022

(51) Int. Cl. G06F 21/62

(52) U.S. Cl. CPC G06F 21/6218

(57) ABSTRACT

An information management device (10) includes: an acquisition unit (100) configured to acquire belonging organization information indicating a belonging organization of an original owner or an original generator of target information; a specification unit (120) configured to, in response to receiving a request for an operation on the target information, specify, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and a restriction unit (140) configured to restrict execution of the operation when at least part of a disclosure range of an operation target path after the operation is not included in the possible disclosure range.

### TECHNICAL FIELD

The present disclosure relates to an information management device, an information management system, an information management method, and a non-transitory computer-readable medium.

### BACKGROUND ART

Managing data stored in a file server by restricting a disclosure range of the data for improvement of information security against information leakage and the like is known. Patent Literature 1 discloses a document management system previously registering disclosure target organization of document data and a related organization thereof as disclosure target organizations and transmitting the document data only when a belonging organization of a user is registered as a disclosure target organization, in order to streamline job execution.

### CITATION LIST

### Patent Literature

Patent Literature 1: Japanese Unexamined Patent Application Publication No. 2012-185780

### SUMMARY OF INVENTION

### Technical Problem

However, the aforementioned document management system described in Patent Literature 1 has a problem that the system cannot prevent document data to be managed or a copy of the data from being circulated from one location to another and being placed at a location accessible to an organization with different business activities.

In view of the aforementioned problem, an object of the present disclosure is to provide an information management device, an information management system, an information management method, and a non-transitory computer-readable medium that can improve confidentiality while streamlining job execution.

### Solution to Problem

An information management device according to an aspect of the present disclosure includes: an acquisition unit configured to acquire belonging organization information indicating a belonging organization of an original owner or an original generator of target information; a specification unit configured to, in response to receiving a request for an operation on the target information, specify, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and a restriction unit configured to restrict execution of the operation when at least part of a disclosure range of an operation target path after the operation is not included in the possible disclosure range.

An information management system according to an aspect of the present disclosure includes: a file server configured to store target information of an operation target; a user terminal configured to specify an operation; an organization user management device configured to store a user and a belonging organization of the user in association with each other; and an information management device configured to include: an acquisition unit configured to acquire belonging organization information indicating a belonging organization of an original owner or an original generator of the target information; a specification unit configured to, in response to receiving a request for an operation on the target information, specify, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and a restriction unit configured to restrict execution of the operation when at least part of a disclosure range of an operation target path after the operation is not included in the possible disclosure range.

An information management method according to an aspect of the present disclosure includes: a step of acquiring belonging organization information indicating a belonging organization of an original owner or an original generator of target information; a step of, in response to receiving a request for an operation on the target information, specifying, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and a step of restricting execution of the operation when at least part of a disclosure range of an operation target path after the operation is not included in the possible disclosure range.

A non-transitory computer-readable medium according to an aspect of the present disclosure has an information management program stored thereon, the information management program causing a computer to provide: an acquisition function of acquiring belonging organization information indicating a belonging organization of an original owner or an original generator of target information; a specification function of, in response to receiving a request for an operation on the target information, specifying, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and a restriction function of restricting execution of the operation when at least part of a disclosure range of an operation target path after the operation is not included in the possible disclosure range.

### Advantageous Effects of Invention

The present disclosure can provide an information management device, an information management system, an information management method, and a non-transitory computer-readable medium that can improve confidentiality while streamlining job execution.

### BRIEF DESCRIPTION OF DRAWINGS

FIG. 1 is a block diagram illustrating a configuration of an information management device according to a first example embodiment;

FIG. 2 is a schematic configuration diagram illustrating an example of an information management system according to a second example embodiment;

FIG. 3 is a diagram illustrating an example of a data structure of a management table according to the second example embodiment;

FIG. 4 is a diagram illustrating an example of a data structure of a disclosure range table according to the second example embodiment;

FIG. 5 is a diagram illustrating an example of a data structure of an organizational layer table according to the second example embodiment;

FIG. 6 is a diagram illustrating an example of a data structure of an operation target management log according to the second example embodiment;

FIG. 7 is a flowchart illustrating processing in an information management device according to the second example embodiment;

FIG. 8 is a diagram illustrating an example of display when operation restriction processing is performed by a restriction unit according to the second example embodiment;

FIG. 9 is a flowchart illustrating possible disclosure range specification processing by a specification unit according to the second example embodiment;

FIG. 10 is a diagram for illustrating the possible disclosure range specification processing according to the second example embodiment;

FIG. 11 is a flowchart illustrating possible disclosure range specification processing by a specification unit according to a third example embodiment;

FIG. 12 is a schematic configuration diagram illustrating an example of an information management system according to a fourth example embodiment;

FIG. 13 is a diagram illustrating an example of a data structure of an upper-limit disclosed layer table according to the fourth example embodiment;

FIG. 14 is a diagram illustrating an example of display when an acquisition unit according to the fourth example embodiment acquires upper-limit disclosed layer information;

FIG. 15 is a flowchart illustrating possible disclosure range specification processing by a specification unit according to the fourth example embodiment;

FIG. 16 is a flowchart illustrating processing in an information management device according to a fifth example embodiment;

FIG. 17 is a diagram illustrating an example of a data structure of an operation target management log according to a sixth example embodiment;

FIG. 18 is a diagram illustrating an example of a data structure of an operation target management log according to a seventh example embodiment; and

FIG. 19 is a schematic configuration diagram of a computer according to the present example embodiment.

### EXAMPLE EMBODIMENT

### First Example Embodiment

A first example embodiment of the present disclosure will be described below with reference to drawings. In each drawing, the same or corresponding components are given the same sign, and redundant description thereof is omitted as needed for clarification of description.

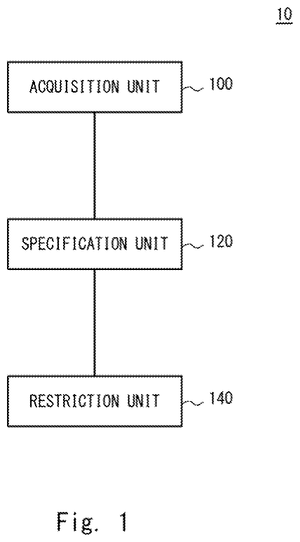

FIG. 1 is a block diagram illustrating a configuration of an information management device 10 according to the first example embodiment. The information management device 10 includes an acquisition unit 100, a specification unit 120, and a restriction unit 140.

The acquisition unit 100 acquires belonging organization information indicating a belonging organization of the original owner or the original generator of target information.

In response to receiving a request for a target operation, the specification unit 120 specifies a possible disclosure range indicating an organization group to which target information or a copy thereof is possibly disclosed, based on job relevance to a belonging organization of the original owner or the original generator. A target operation is an operation performed on target information and is an operation accompanied by change of a disclosure range of the target information or a copy thereof, the disclosure range being set to a path to the target information or the copy thereof.

The restriction unit 140 restricts execution of a target operation when at least part of a disclosure range of an operation target path after the operation is not included in a possible disclosure range.

Thus, with the configuration according to the first example embodiment, the information management device 10 restricts an operation when a disclosure range after the operation is not included in a possible disclosure range based on job relevance to a belonging organization of an original owner or an original generator. Thus, target information or a copy thereof being circulated from one location to another and being placed at a location accessible to an organization with business activities different from that of an original related organization can be prevented, and confidentiality can be improved. On the other hand, when the disclosure range after the operation is included in the possible disclosure range, sharing of the target information with a member of an organization not included in a disclosure range before the operation is enabled, and job execution can be further streamlined.

### Second Example Embodiment

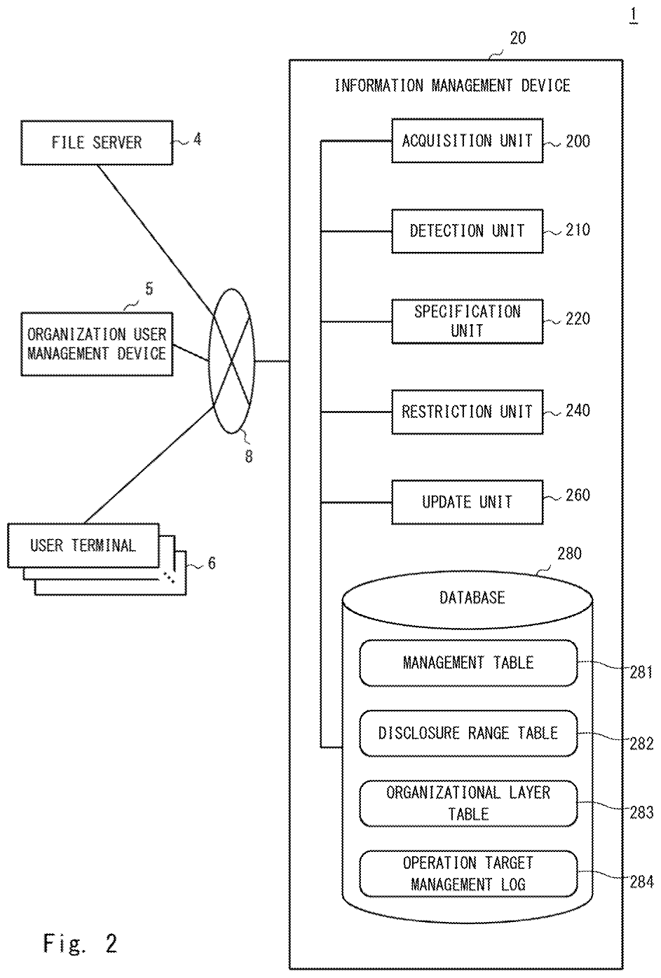

Next, a second example embodiment of the present disclosure will be described by using FIGS. 2 to 10. FIG. 2 is a schematic configuration diagram illustrating an example of an information management system 1 to which an information management device 20 according to the second example embodiment is applicable.

The information management system 1 stores and manages information related to a job in an organization of a user (job-related information). Job-related information includes confidential information. Examples of a user of the information management system 1 include an executive and an employee of a company, and examples of an organization include an entire company, and a department, a section, and a job group within the company. One or a plurality of users directly or indirectly belong to each organization. Each organization has a directly related organization in at least one of a superior position and a subordinate position. Further, each organization may have an affiliated organization in at least one of a superior position and a subordinate position.

The information management system 1 includes a file server 4, an organization user management device 5, one or a plurality of user terminals 6, and an information management device 20; and the components are configured to be communicably connected to each other through a network 8.

The network 8 is configured to include various networks such as the Internet, a wide area network (WAN), and a local area network, or a combination thereof. Further, the network 8 may include a dedicated line isolated from the Internet.

The file server 4 is a computer such as a server computer and stores job-related information. The file server 4 stores job-related information by using a file. In response to receiving a request for an operation such as registration, change, deletion, browsing, moving, copying, or access right change of job-related information from the user terminal 6 through the information management device 20, the file server 4 receives control from the information management device 20 and executes an operation based on the control.

The organization user management device 5 is a computer such as a server computer storing a user and user attribute information such as a belonging organization of the user in association with each other. The organization user management device 5 also stores organizational layer information indicating connection between organizations, and layers. As an example, the organization user management device 5 may be part of a directory server used by a domain controller providing a domain service such as Active Directory (registered trademark). In response to receiving a request from the information management device 20, the organization user management device 5 transmits user attribute information and organizational layer information that are associated with a user to the information management device 20.

Examples of the user terminal 6 include devices used by users such as a personal computer, a notebook computer, a mobile phone, a smartphone, and other terminal devices allowing input and output of data. The user terminal 6 specifies an operation such as registration, change, deletion, browsing, moving, copying, or access right change of job-related information in the file server 4 and transmits a request for the operation to the file server 4 through the information management device 20.

The information management device 20 is a computer such as a server computer managing job-related information to be managed within job-related information stored in the file server 4. The information management device 20 transmits and receives various types of information to and from the file server 4, the organization user management device 5, and the user terminal 6 through the network 8. The information management device 20 manages job-related information to be managed being stored in the file server 4 and file attribute information of a file including the job-related information in association with each other. The file attribute information may include a path to the file (file path) and information indicating an access right and an owner of the file path. Further, in response to receiving a request for an operation on job-related information from the user terminal 6, the information management device 20 performs control on the file server 4, such as permitting or restricting execution of the operation.

The information management device 20 includes an acquisition unit 200, a detection unit 210, a specification unit 220, a restriction unit 240, an update unit 260, and a database 280.

The acquisition unit 200 acquires various types of file attribute information of job-related information to be managed being stored in the file server 4. Further, the acquisition unit 200 acquires user attribute information including belonging organization information indicating a belonging organization of the original owner of job-related information being a target of an operation by the user terminal 6 (target information) within the job-related information to be managed. An original owner may be the owner of a file including original job-related information at the time of generation of the file or the present owner of the file including the original job-related information. Being original may refer to not being a copy. The acquisition unit 200 stores the various types of acquired information into the database 280. Further, the acquisition unit 200 refers to the database 280 and outputs various types of information stored in the database 280 to the specification unit 220, the restriction unit 240, and the like.

In response to receiving a request for an operation on target information specified by the user terminal 6 (user-specified operation), the detection unit 210 detects a target operation being a restriction target in the user-specified operation. A user-specified operation may include registration, deletion, change, browsing, moving, copying, and access right change of target information. Further, a target operation is an operation accompanied by change of a disclosure range of target information or a copy of the target information, the disclosure range being set to a path to the target information or a copy thereof. A disclosure range indicates an organization group given with an access right to a file path of a file including target information or a copy thereof. Accordingly, an organization included in a disclosure range of target information or a copy thereof can, for example, actually access and browse the target information or the copy thereof. For example, moving of target information, copying of the target information, and moving of the copy, and change of an access right are operations that are possibly target operations. A target operation is an operation for which a disclosure range of a file path of the operation target (operation target path) is different from a disclosure range of a file path of target information or a copy thereof being a file path of the operation source (operation source path), out of operations that are possibly the target operation. As an example, a target operation may be an operation for which at least part of a disclosure range of the operation target path is not included in a disclosure range of the operation source path, out of operations that are possibly the target operation.

In response to detection of a target operation, the specification unit 220 specifies a possible disclosure range indicating an organization group to which target information or a copy thereof is possibly disclosed, based on job relevance to a belonging organization of the original owner. A possible disclosure range indicates an organization group that is set to target information or a copy thereof independently of an access right and is possibly able to access the target information or the copy thereof. Specifically, a possible disclosure range may be an organization group given with a virtual access right to target information or a copy thereof. Accordingly, an organization being included in a possible disclosure range of target information or a copy thereof but not being included in a disclosure range of a file path of the target information cannot actually access the target information. Specifically, the specification unit 220 specifies a possible disclosure range of target information or a copy thereof, based on an organizational layer of a belonging organization of the original owner. The specification unit 220 outputs information indicating the specified possible disclosure range to the restriction unit 240.

When at least part of a disclosure range of an operation target path after a target operation is not included in a possible disclosure range of target information or a copy thereof, the restriction unit 240 controls the file server 4 in such a way that execution of the target operation is restricted. On the other hand, when a user-specified operation is not a target operation or when the user-specified operation is a target operation and a disclosure range of an operation target path after the target operation is included in a possible disclosure range of the target information or a copy thereof, the restriction unit 240 controls the file server 4 in such a way that execution of the user-specified operation is permitted.

In response to execution of a user-specified operation, the update unit 260 updates an operation target management log 284 in the database 280.

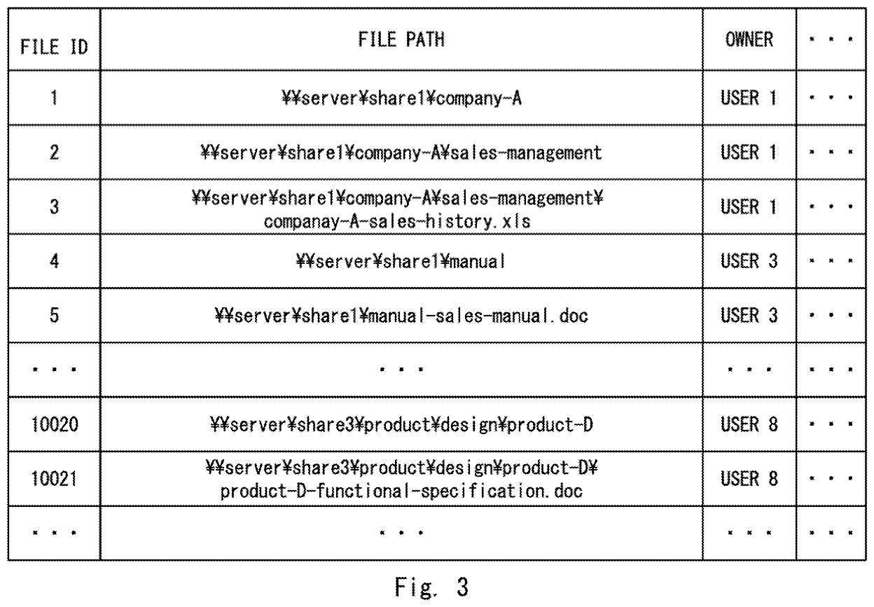

The database 280 stores various types of information required for management of job-related information to be managed in the file server 4. The database 280 inputs and outputs various types of information from and to the acquisition unit 200, the detection unit 210, the specification unit 220, the restriction unit 240, and the update unit 260 in the information management device 20. The database 280 includes a management table 281, a disclosure range table 282, an organizational layer table 283, and the operation target management log 284. Details of the tables or the log will be described by using FIGS. 3 to 6.

FIG. 3 is a diagram illustrating an example of a data structure of the management table 281 according to the second example embodiment.

The management table 281 stores file attribute information such as a file path and an owner of a file including job-related information to be managed, the file attribute information being acquired from the file server 4 by the acquisition unit 200. For example, the management table 281 stores file identification information, a file path, and information indicating an owner in association with each other.

File identification information is information for identifying a file including job-related information to be managed. Specifically, file identification information is identification information for identifying a file path of a file. As an example, file identification information may be a serial number.

A file path indicates a file path of a file related to file identification information.

Information indicating an owner indicates an owner of a file placed at a location indicated by a file path.

The management table 281 may include a file name for improved convenience of information management.

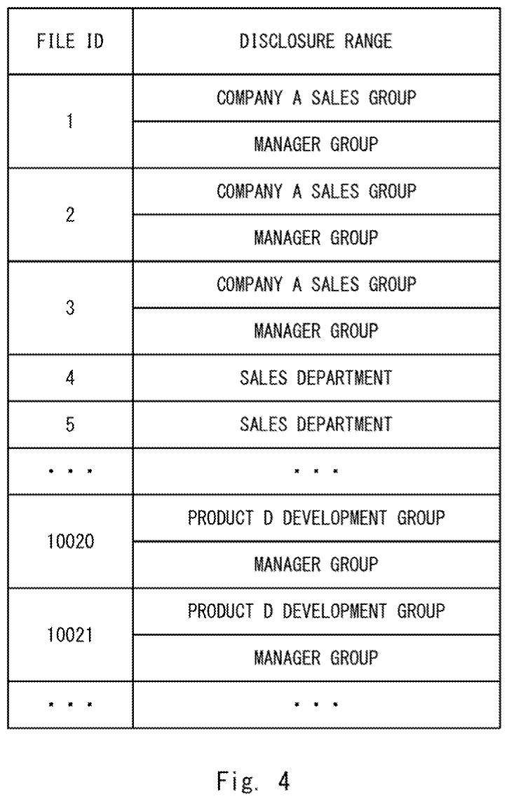

FIG. 4 is a diagram illustrating an example of a data structure of the disclosure range table 282 according to the second example embodiment.

The disclosure range table 282 stores disclosure range information based on an access right set to a file path, the disclosure range information being acquired from the file server 4 and the organization user management device 5 by the acquisition unit 200. For example, the disclosure range table 282 stores file identification information and information indicating an organization included in a disclosure range in association with each other.

File identification information is similar to file identification information in the management table 281, and description thereof is omitted.

Information indicating an organization included in a disclosure range indicates an organization given with an access right to a file path.

As illustrated in the diagram, one file may be accessible to one or a plurality of organizations. In other words, one or a plurality of organizations may have an access right to one file path.

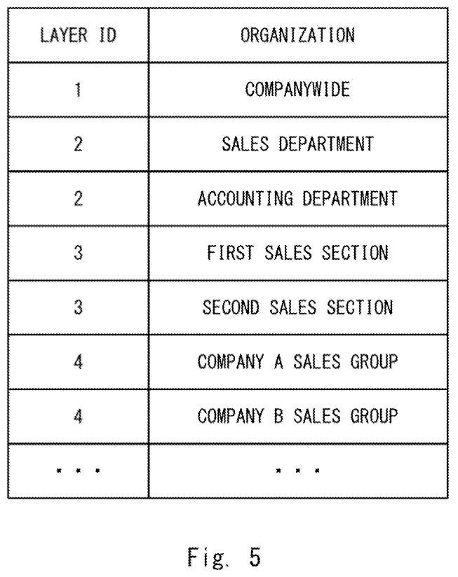

FIG. 5 is a diagram illustrating an example of a data structure of the organizational layer table 283 according to the second example embodiment.

The organizational layer table 283 stores organizational layer information acquired from the organization user management device 5. For example, the organizational layer table 283 stores layer identification information and an organization in association with each other. Organizational layer information may be predetermined based on relevance to a job of an organization.

Layer identification information is information for identifying the rank of a layer in an entire organization. For example, layer identification information may be a number. For example, as illustrated in the diagram, layer identification information of a companywide organization may be “1,” layer identification information of a sales department and an accounting department being subordinate organizations of the companywide organization may be “2,” and layer identification information of a first sales section and a second sales section being subordinate organizations of the sales department may be “3.”

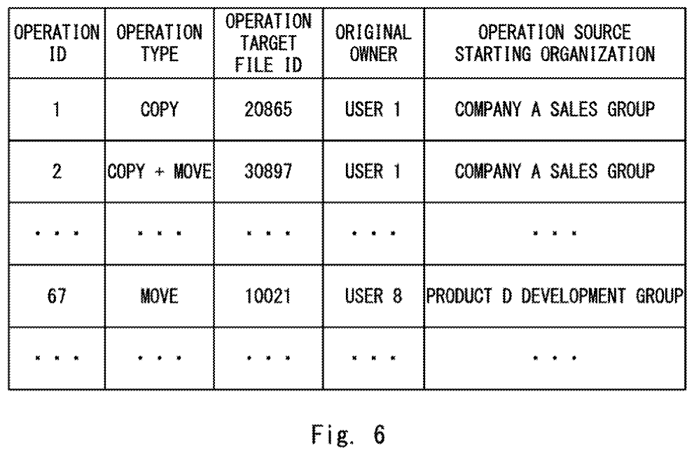

FIG. 6 is a diagram illustrating an example of a data structure of the operation target management log 284 according to the second example embodiment. The operation target management log 284 stores attribute information related to an operation executed by the file server 4. The operation target management log 284 according to the present second example embodiment stores attribute information related to an operation possibly being a target operation out of operations executed by the file server 4. For example, the operation target management log 284 stores operation target file identification information for identifying an operation target path and the original owner of target information being an operation source in association with each other. As illustrated in the diagram, the operation target management log 284 may store operation identification information, an operation type, operation target file identification information, original owner information, and operation source starting organization information in association with each other.

Operation identification information is information for identifying an executed operation. As an example, operation identification information may be a number. As an example, operation identification information may be time-series identification number based on a time at which an operation is executed.

An operation type indicates the type of an executed operation. An operation type according to the present second example embodiment may be the type of an operation possibly being a target operation, such as “move,” “copy,” “copy and move,” and “access right change.”

Operation target file identification information is file identification information of a file being an operation target of an executed operation. In other words, operation target file identification information indicates identification information of an operation target path. Operation target file identification information according to the present second example embodiment is file identification information of a file being an operation target of an operation possibly being a target operation. When the operation type of an operation possibly being a target operation is “access right change,” operation target file identification information may be file identification information of a file including target information related to the change. As an example, operation target file identification information may be a number.

Original owner information is information indicating the original owner of original information of a file being an operation source.

Operation source starting organization information is information indicating an operation source starting organization being a belonging organization of an original owner. Operation source starting organization information may be acquired from the organization user management device 5 through the acquisition unit 200.

For example, as illustrated in the diagram, an operation with operation identification information “1” is an operation of “copying” a file being an operation source to a file with file identification information “20865.” The original owner of original information being the operation source related to the operation is “User 1,” and a belonging organization of User 1 is “Company A Sales Group.”

Note that either of original owner information and operation source starting organization information may be omitted in the operation target management log 284.

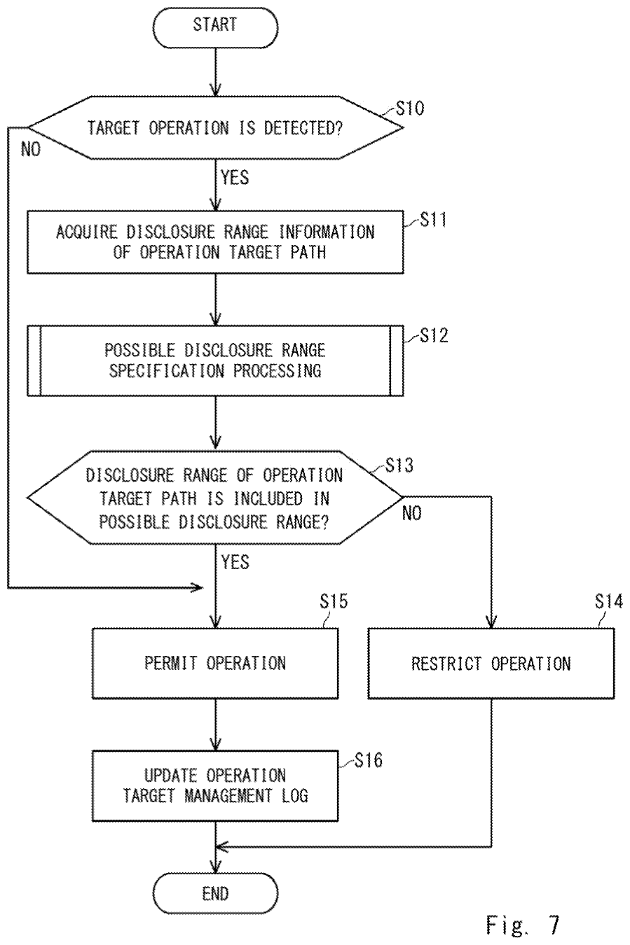

FIG. 7 is a flowchart illustrating processing in the information management device 20 according to the second example embodiment.

First, in S10, in response to receiving a request for a user-specified operation, the detection unit 210 in the information management device 20 determines whether a target operation is detected from the user-specified operation. Specifically, the detection unit 210 determines whether the user-specified operation includes an operation possibly being a target operation and the user-specified operation includes a target operation. The detection unit 210 advances the processing to S11 when a target operation is detected (YES in S10) and advances the processing to S15 when a target operation is not detected (NO in S10).

In S11, the acquisition unit 200 refers to the disclosure range table 282 in the database 280 and acquires disclosure range information set to an operation target path to the target operation. The acquisition unit 200 outputs the disclosure range information to the specification unit 220.

Next, in S12, the specification unit 220 performs possible disclosure range specification processing and specifies a possible disclosure range of the target information or a copy thereof. The specification unit 220 outputs information indicating the possible disclosure range to the restriction unit 240.

Next, in S13, the restriction unit 240 determines whether the disclosure range of the operation target path is included in the possible disclosure range. The restriction unit 240 advances the processing to S15 when the disclosure range is completely included in the possible disclosure range (YES in S13) and advances the processing to S14 when at least part of the disclosure range is not included in the possible disclosure range (NO in S13).

In S14, the restriction unit 240 controls the file server 4 in such a way that execution of the target operation is restricted. Then, the restriction unit 240 ends the processing.

In S15, in response to not detecting a target operation from the user-specified operation in S10 or in response to determining that the disclosure range of the operation target path is completely included in the possible disclosure range in S13, the restriction unit 240 permits execution of the user-specified operation.

Next, in S16, in response to execution of the user-specified operation being permitted and the user-specified operation being executed, the update unit 260 updates the operation target management log 284 in the database 280. The update unit 260 may update the operation target management log 284 only when the user-specified operation is an operation possibly being a target operation or being a target operation. An operation possibly being a target operation or being a target operation is referred to as a target-related operation.

The update unit 260 determines whether a record including operation target file identification information matching file identification information of the operation source of the executed target-related operation exists in records stored in the operation target management log 284. The file identification information of the operation source of the target-related operation indicates identification information of an operation source path. Specifically, the update unit 260 determines whether the executed target-related operation is a second or subsequent target-related operation. Then, when the determination result is yes, the update unit 260 newly associates file identification information of the operation target of the target-related operation with original owner information and belonging organization information of a belonging organization of the original owner (that is, operation source starting organization information) associated with the matching operation target file identification information. At this time, the update unit 260 may add a new record related to the target-related operation. Otherwise, the owner in the management table 281 is the original owner, and therefore the update unit 260 adds, to the operation target management log 284, a record including information indicating the original owner and belonging organization information indicating the belonging organization thereof as attribute information related to the target-related operation. Then, the update unit 260 ends the processing.

A flag indicating that attribute information related to an operation is updated in the operation target management log 284 may be added to a record of a related file in the management table 281. In this case, in S16, the update unit 260 may determine whether an executed target-related operation is a second or subsequent target-related operation by determining whether a flag is set in a record related to file identification information of the target-related operation in the management table 281.

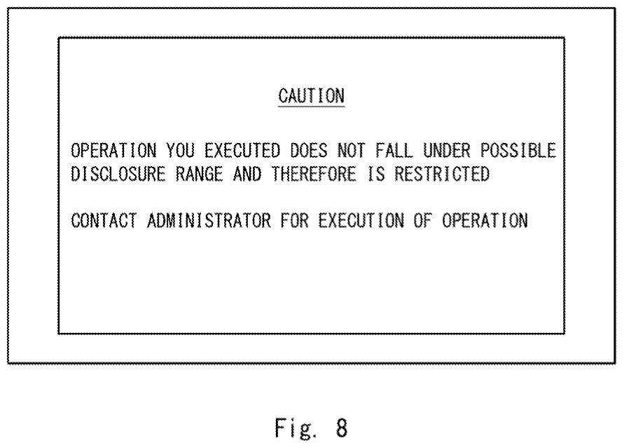

FIG. 8 is a diagram illustrating an example of display when execution restriction processing (the processing described in S14 in FIG. 7) on an operation is performed by the restriction unit 240 according to the second example embodiment.

The restriction unit 240 transmits, to the user terminal 6, data indicating that execution of a user-specified operation is restricted since a disclosure range of the operation target of the user-specified operation is not included in a possible disclosure range. In response to receiving the data, the user terminal 6 notifies a user of the received data by causing a display device (unillustrated) of the user terminal 6 to display the data as illustrated in the diagram. At this time, the restriction unit 240 may prompt the user to contact an administrator when execution of a similar user-specified operation is desired.

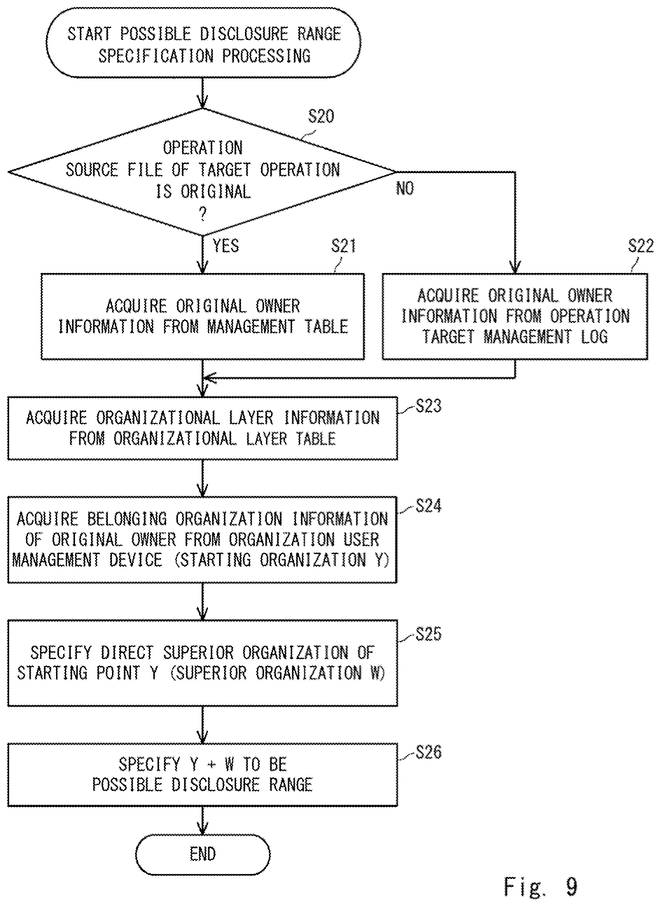

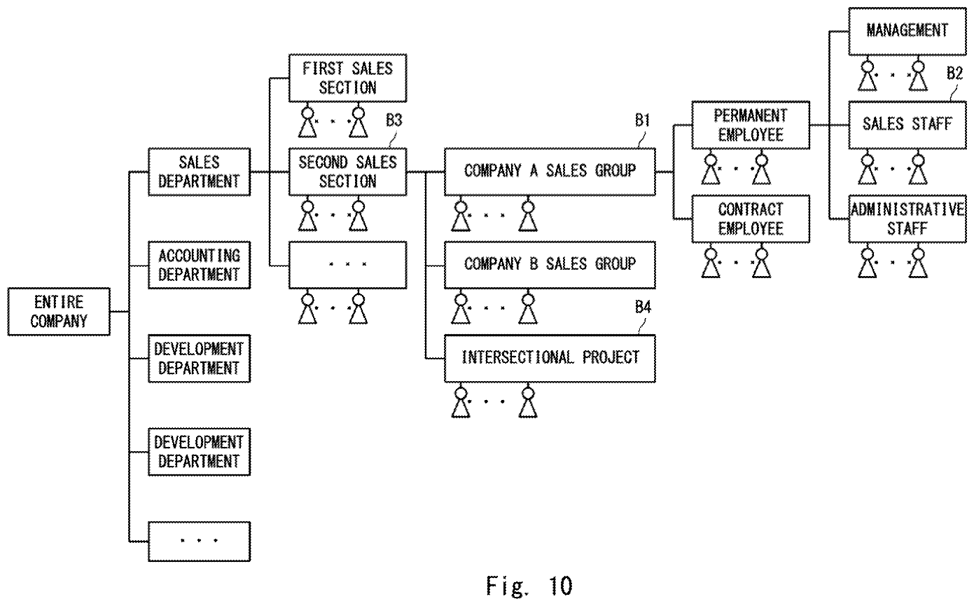

Next, possible disclosure range specification processing (the processing described in S12 in FIG. 7) by the specification unit 220 according to the second example embodiment will be described by using FIG. 9 with reference to FIG. 10.

FIG. 9 is a flowchart illustrating the possible disclosure range specification processing by the specification unit 220 according to the second example embodiment. Further, FIG. 10 is a diagram for illustrating the possible disclosure range specification processing according to the second example embodiment.

First, in S20, the specification unit 220 determines whether job-related information included in an operation source file of a target operation is original. Specifically, the specification unit 220 determines whether a record with operation target file identification information matching file identification information of the operation source of the target operation exists in records stored in the operation target management log 284. In other words, the specification unit 220 determines whether the target operation is a second or subsequent target-related operation. The specification unit 220 advances the processing to S21 when the information in the operation source file is original (YES in S20), and advances the processing to S22 otherwise (NO in S20).

In S21, in response to determining that the job-related information included in the operation source file is original in S20, the specification unit 220 refers to the management table 281 and acquires original owner information with the owner of the operation source file as an original owner. Then, the specification unit 220 advances the processing to S23.

In S22, the specification unit 220 refers to the operation target management log 284 and acquires an original owner associated with operation target file identification information matching the file identification information of the operation source of the target operation as original owner information. Then, the specification unit 220 advances the processing to S23.

Next, in S23, the specification unit 220 acquires organizational layer information from the organizational layer table 283.

In S24, the specification unit 220 acquires belonging organization information of the original owner from the organization user management device 5 through the acquisition unit 200. The specification unit 220 determines the belonging organization of the original owner to be a starting organization Y. When a plurality of belonging organizations of the original owner exist, the specification unit 220 may acquire information indicating a disclosure range of the operation source path of the target operation from the disclosure range table 282 through the acquisition unit 200 and determine a starting organization Y, based on the disclosure range of the operation source path.

For example, it is assumed that the original owner in the original owner information acquired in S22 belongs to “Sales Staff” (B2) under “Permanent Employee” being a subordinate organization of “Company A Sales Group” (B1), and “Intersectional Project” (B4), as illustrated in FIG. 10. Note that “Second Sales Section” (B3) is a superior organization of both “Company A Sales Group” (B1) and “Intersectional Project” (B4). It is further assumed that the disclosure range of the operation source path of the target operation includes “Company A Sales Group” (B1) and “Sales staff” (B2) being a subordinate thereof but does not include “Intersectional Project” (B4). In this case, the specification unit 220 determines the starting organization Y to be “Sales staff” (B2) being a subordinate of “Company A sales group” (B1). Then, the specification unit 220 advances the processing to S25.

When determining that the job-related information included in the operation source file is not original in S20, the specification unit 220 may omit the processing in S22 to S24. In this case, the specification unit 220 may refer to the operation target management log 284, acquire operation source starting organization information associated with operation target file identification information matching the file identification information of the operation source, and determine the organization to be the starting organization Y. Then, the specification unit 220 may acquire organizational layer information from the organizational layer table 283 and advance the processing to S25.

Then, in S25, the specification unit 220 traces superior layers in the organizational hierarchy with the starting organization Y as a starting point by using the organizational layer information and specifies a direct superior organization of the belonging organization. The specification unit 220 determines the superior organization to be a superior organization W.

As illustrated in FIG. 10, direct superior organizations of “Sales staff” (B2) being the starting organization Y include “Permanent Employee,” “Company A Sales Group” (B1), “Second Sales Section” (B3), and “Sales Department.” Accordingly, the specification unit 220 may specify “Permanent Employee,” “Company A Sales Group” (B1), “Second Sales Section” (B3), and “Sales Department” as the superior organizations W.

Next, in S26, the specification unit 220 specifies an organization group including the starting organization Y and the superior organizations W to be a possible disclosure range.

“Intersectional Project” (B4) to which the original owner also belongs as illustrated in FIG. 10 is not included in the possible disclosure range. The reason is that the business activities of “Intersectional Project” (B4) is possibly different from that of “Sales staff” (B2) being a subordinate of “Company A Sales Group” (B1) in consideration of the disclosure range of the operation source path to the target information.

Thus, the specification unit 220 specifies a possible disclosure range of target information or a copy thereof with a belonging organization of the original owner as a starting point, based on an organizational hierarchy based on job relevance and a disclosure range of an operation source path. The possible disclosure range may only include the belonging organization of the original owner and an organization in a direct line thereof and may not include an organization not being in a direct line of the belonging organization of the original owner.

Thus, the information management device 20 according to the present second example embodiment restricts execution of an operation when a disclosure range after the operation is not included in a possible disclosure range specified based on job relevance to a belonging organization of an original owner. Thus, target information or a copy thereof being circulated from one location to another and being placed at a location accessible to an organization with business activities different from that of an organization included in an original disclosure range can be prevented, and confidentiality can be improved. On the other hand, when the disclosure range after the operation is included in the possible disclosure range, sharing of the target information with a member of an organization not included in the disclosure range before the operation is enabled, and job execution can be further streamlined.

Note that, in consideration of a possibility that an affiliated organization does not have much job relevance although the organization is close in terms of organizational hierarchy, the specification unit 220 specifies only a belonging organization of an original owner and an organization in a direct line thereof as a possible disclosure range. Thus, target information being placed at an unintended location from a viewpoint of the original owner and being browsed can be prevented.

Further, in response to execution of a target-related operation, the update unit 260 causes the operation target management log 284 to store the latest attribute information including original owner information and belonging organization information thereof. Thus, even when a second or subsequent target-related operation in terms of original job-related information is performed, the original attribute information used for specification of a starting organization

Y can be inherited to a record related to the target-related operation.

Further, the specification unit 220 specifies a possible disclosure range by using organizational layer information, a disclosure range of an operation source path, and the like every time a target-related operation is performed, and therefore an administrator does not need to register a possible disclosure range of the target information or a copy thereof. Thus, even when restructuring of an organization, change of an access right, or the like occurs, the specification unit 220 can specify the latest possible disclosure range while restraining a load on the administrator.

### Third Example Embodiment

A third example embodiment is characterized by a possible disclosure range including a subordinate organization of a starting organization Y. An information management system 1 and an information management device 20 according to the third example embodiment are similar to the information management system 1 and the information management device 20 according to the second example embodiment, and therefore description thereof is omitted.

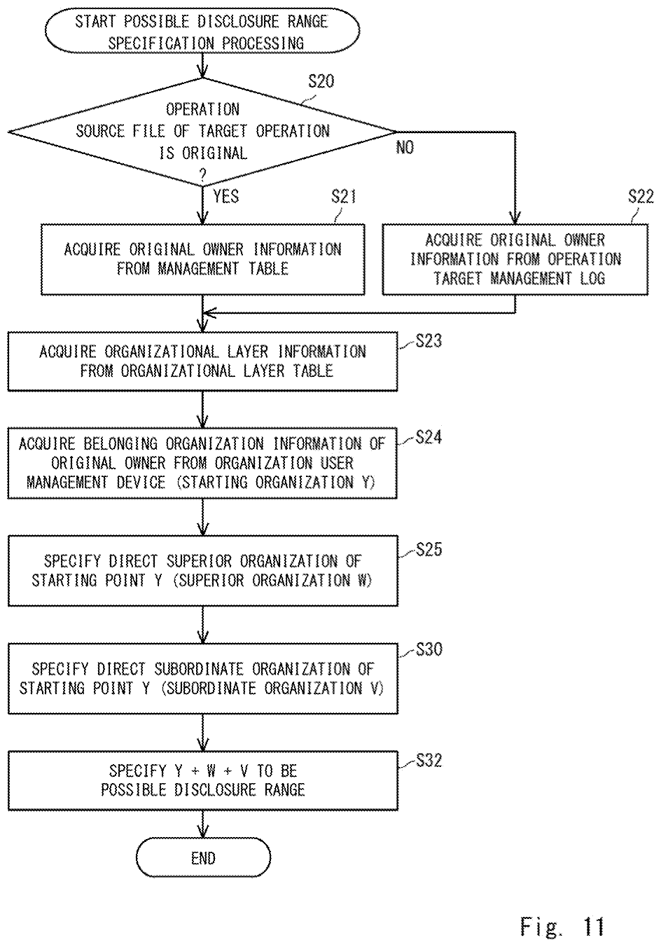

FIG. 11 is a flowchart illustrating possible disclosure range specification processing by a specification unit 220 according to the third example embodiment. Steps described in FIG. 11 include S30 to S32 in place of S26 described in FIG. 9 in the second example embodiment. Note that a step similar to a step described in FIG. 9 is given the same sign, and description thereof is omitted.

In S30, in response to specifying a superior organization W in S25, the specification unit 220 traces subordinate layers in an organizational hierarchy with the starting organization Y as a starting point by using organizational layer information and specifies a direct subordinate organization of the belonging organization. The specification unit 220 determines the subordinate organization to be a subordinate organization V.

Next, in S32, the specification unit 220 specifies an organization group including the starting organization Y, the superior organization W, and the subordinate organization V to be a possible disclosure range.

Thus, according to the present third example embodiment, a possible disclosure range also includes a subordinate organization of a starting organization Y, and therefore information sharing is accelerated and job execution can be further streamlined.

### Fourth Example Embodiment

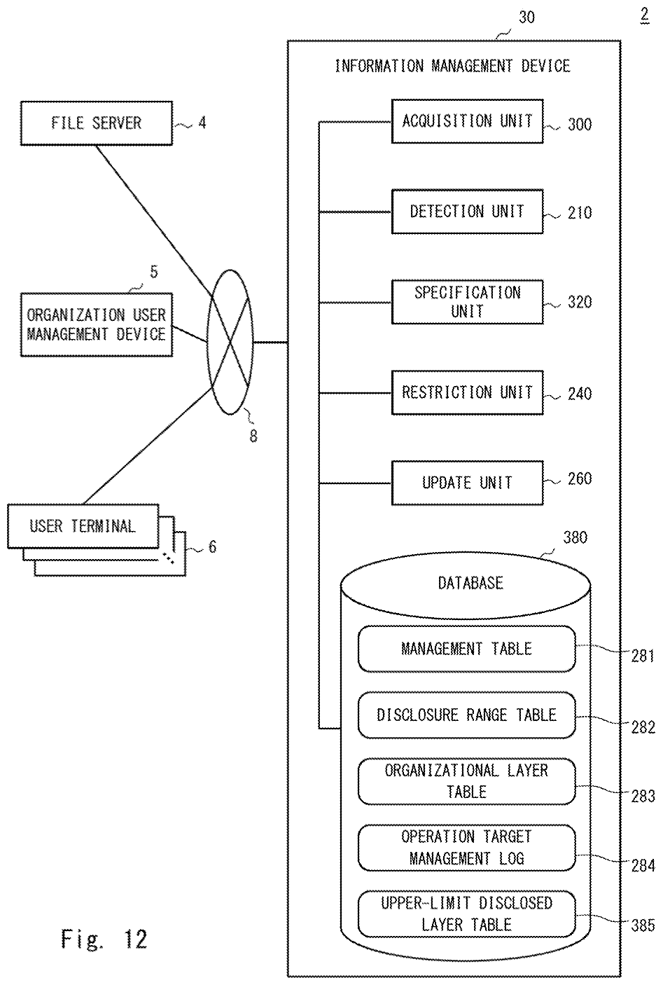

Next, a fourth example embodiment of the present disclosure will be described by using FIGS. 12 to 15. The fourth example embodiment is characterized by specifying a possible disclosure range, based on an upper-limit disclosed layer.

FIG. 12 is a schematic configuration diagram illustrating an example of an information management system according to the fourth example embodiment. The information management system 2 has a configuration and functions basically similar to those of the information management system 1 according to the second example embodiment. However, the information management system 2 differs from the information management system 1 in including an information management device 30 in place of the information management device 20.

The information management device 30 is a computer having a configuration and functions basically similar to those of the information management device 20. However, the information management device 30 includes an acquisition unit 300, a specification unit 320, and a database 380 in place of the acquisition unit 200, the specification unit 220, and the database 280.

In addition to the configuration and the functions of the acquisition unit 200, the acquisition unit 300 acquires, from an administrator, upper-limit disclosed layer information being information indicating an upper-limit disclosed layer of job-related information to be managed being stored in a file server 4, through a user terminal 6 or an input device (unillustrated) in the information management device 30. An upper-limit disclosed layer indicates an organizational layer being an upper limit of a possible disclosure range. An upper-limit disclosed layer according to the present fourth example embodiment may be the rank of an organizational layer being an upper limit of a possible disclosure range. The acquisition unit 300 stores the acquired upper-limit disclosed layer information into an upper-limit disclosed layer table 385 in the database 380.

In addition to the configuration and the functions of the specification unit 220, the specification unit 320 specifies a possible disclosure range of target information or a copy thereof, based on an organizational layer of a belonging organization of the original owner and an upper-limit disclosed layer.

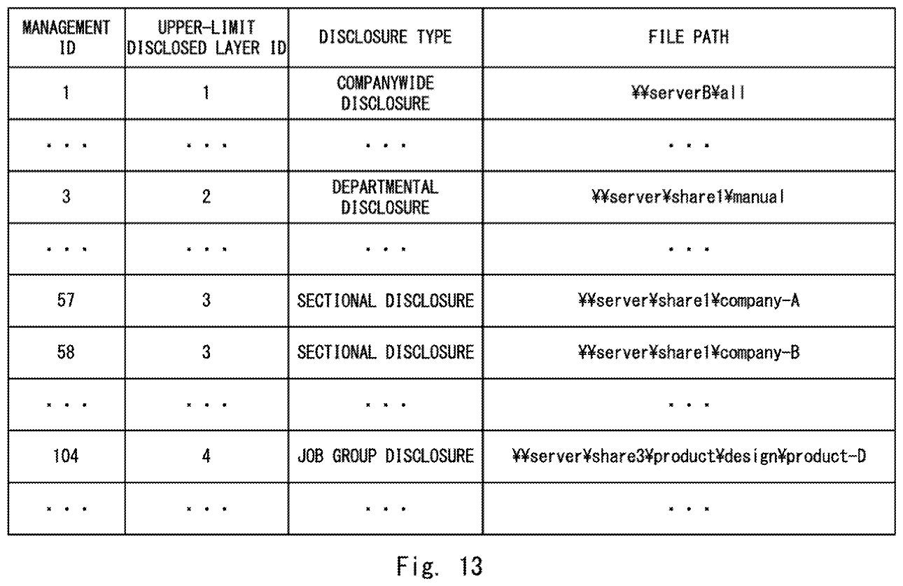

In addition to the configuration and the functions of the database 280, the database 380 stores an upper-limit disclosed layer table 385. Details of the upper-limit disclosed layer table 385 will be described by using FIG. 13.

FIG. 13 is a diagram illustrating an example of a data structure of the upper-limit disclosed layer table 385 according to the fourth example embodiment.

The upper-limit disclosed layer table 385 stores upper-limit disclosed layer information acquired from an administrator by the acquisition unit 300. For example, the upper-limit disclosed layer table 385 stores management identification information, upper-limit disclosed layer identification information, a disclosure type, and a file path in association with each other.

Management identification information is identification information about management of upper-limit disclosed layer information.

Upper-limit disclosed layer identification information is information for identifying an upper limit of a disclosed organizational layer and is particularly for identifying the rank of the organizational layer. As an example, upper-limit disclosed layer identification information may be a number.

A disclosure type indicates the type of the rank of an upper limit of a disclosed organizational layer. Examples of a disclosure type may include “companywide disclosure,” “departmental disclosure,” “sectional disclosure,” and “job group disclosure.”

Upper-limit disclosed layer identification information may be previously associated with a disclosure type. For example, upper-limit disclosed layer identification information may be “1” when a disclosure type is “companywide disclosure,” and upper-limit disclosed layer identification information may be “2” when a disclosure type is “departmental disclosure.”

A file path is similar to a file path described in FIG. 3, and therefore description thereof is omitted.

For improved convenience of information management, the management table 281 may additionally store upper-limit disclosed layer identification information.

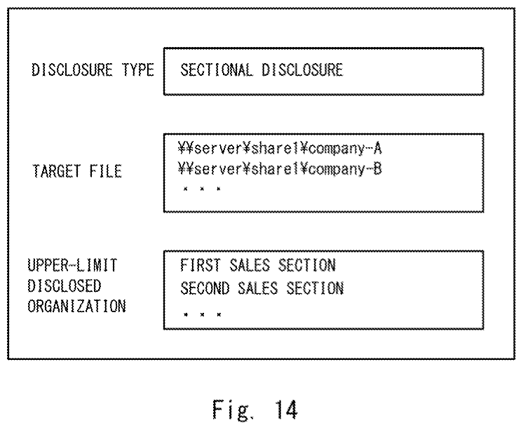

FIG. 14 is a diagram illustrating an example of display when the acquisition unit 300 according to the fourth example embodiment acquires upper-limit disclosed layer information.

In response to a request from an administrator, the acquisition unit 300 causes a display device (unillustrated) on a requester (the user terminal 6 of the administrator or the information management device 30) to display an input screen for inputting a disclosure type and a path to a target file. The acquisition unit 300 registers upper-limit disclosed layer information in the upper-limit disclosed layer table 385, based on the acquired disclosure type and the acquired path to the target file.

In response to a request from an administrator, the acquisition unit 300 may cause the display device (unillustrated) on the requester (the user terminal 6 of the administrator or the information management device 30) to display an input screen for inputting an upper-limit disclosed organization, as illustrated in the diagram. In this case, in response to input of a disclosure type, the acquisition unit 300 may cause a list of organization names related to upper-limit disclosed layer identification information based on the disclosure type to be displayed and acquire information indicating an upper-limit disclosed organization by the administrator selecting the upper-limit disclosed organization from the list. Then, the acquisition unit 300 may register the information indicating the upper-limit disclosed organization in a target record in the upper-limit disclosed layer table 385.

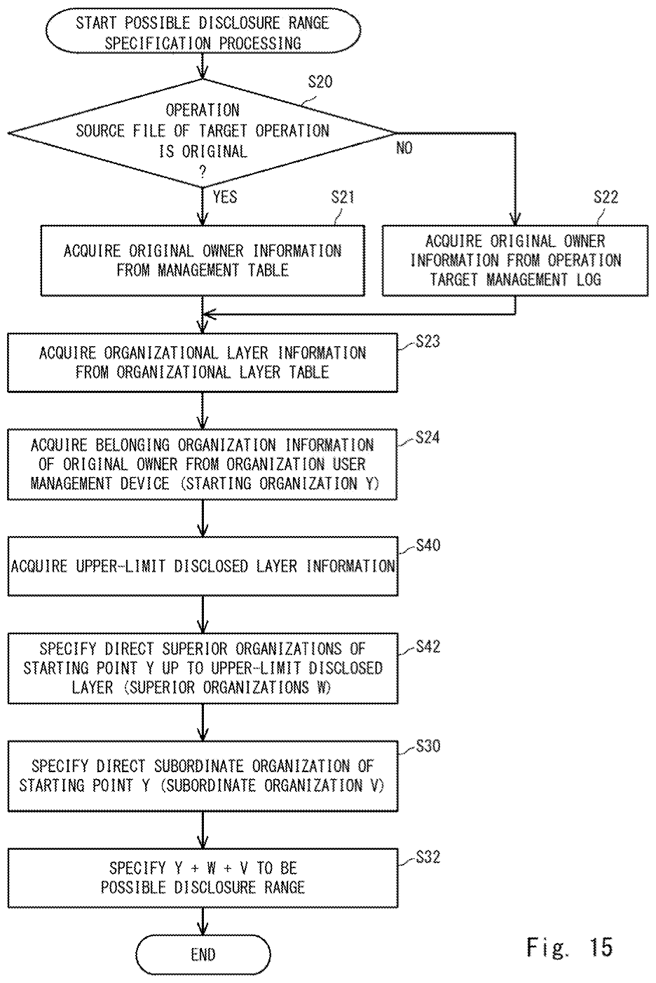

Next, possible disclosure range specification processing by the specification unit 320 will be described by using FIG. 15 with reference to FIG. 10. FIG. 15 is a flowchart illustrating the possible disclosure range specification processing by the specification unit 320 according to the fourth example embodiment. Steps described in FIG. 15 include S40 to S42 in addition to the steps described in FIG. 11 in the third example embodiment. Note that a step similar to a step described in FIG. 11 is given the same sign, and description thereof is omitted.

In S40, in response to specifying a belonging organization of an original owner to be a starting organization Y in S24, the specification unit 320 refers to the upper-limit disclosed layer table 385 and acquires upper-limit disclosed layer information such as upper-limit disclosed layer identification information or a disclosure type associated with an operation source path of a target operation.

Then, in S42, the specification unit 320 specifies superior organizations W in a direct line of the starting organization Y up to an upper-limit disclosed layer related to the upper-limit disclosed layer identification information, by using organizational layer information and the upper-limit disclosed layer information.

For example, a case of the upper-limit disclosed layer identification information being “3” and the disclosure type being “sectional disclosure” will be described. When the starting organization Y is “Sales staff” (B2) as illustrated in FIG. 10, the upper-limit disclosed organization is “Second Sales Section” (B3) being a direct superior organization of “Sales staff” (B2) and having a rank of a section. Accordingly, the specification unit 320 specifies “Permanent Employee,” “Company A Sales Group,” (B1) and “Second Sales Section” (B3) as superior organizations W.

Thus, the information management device 30 according to the fourth example embodiment specifies a possible disclosure range, based on upper-limit disclosed layer information previously registered by an administrator. Accordingly, the possible disclosure range can be limited according to a degree of confidentiality or the like of target information, and therefore convenience of information management is improved. The administrator has only to set upper-limit disclosed layer information to information to be managed being stored in the file server 4 and register the set information, and therefore a load on the administrator can be minimized.

### Fifth Example Embodiment

A fifth example embodiment is characterized by an information management device 40 permitting execution of a target operation under a predetermined condition even when a disclosure range of an operation target is not included in a possible disclosure range.

The information management device 40 according to the fifth example embodiment is a computer having a configuration and functions basically similar to those of the information management device 30 according to the fourth example embodiment. However, the information management device 40 includes a restriction unit 440 in place of the restriction unit 240.

In addition to the functions and the configuration of the restriction unit 240, the restriction unit 440 controls a file server 4 in such a way that a target operation is permitted under a predetermined condition. For example, the restriction unit 440 controls the file server 4 in such a way that a target operation is permitted depending on the ratio between the number of persons in an organization included in a possible disclosure range and the number of persons in an organization not included in the possible disclosure range, in organizations belonging to a disclosure range of an operation target path after the operation.

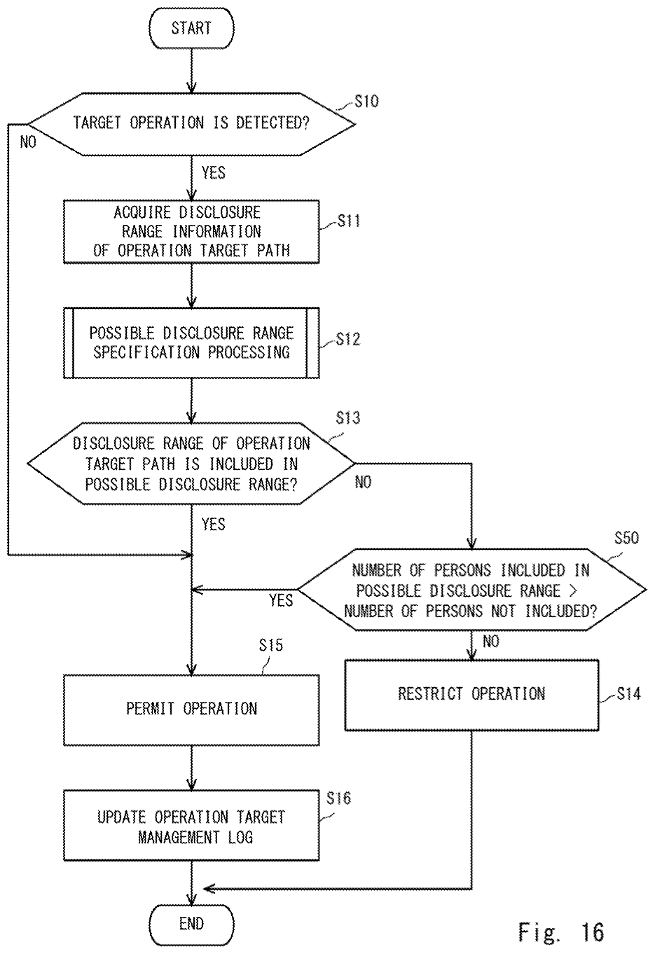

FIG. 16 is a flowchart illustrating processing in the information management device 40 according to the fifth example embodiment. Steps described in FIG. 16 include S50 in addition to the steps described in FIG. 7 in the second example embodiment. Note that a step similar to a step described in FIG. 7 is given the same sign, and description thereof is omitted.

In S50, in response to determining that at least part of a disclosure range is not included in a possible disclosure range in S13 (NO in S13), the restriction unit 440 determines whether the number of persons in an organization included in the possible disclosure range is greater than the number of persons in an organization not included in the possible disclosure range. The restriction unit 440 advances the processing to S15 when the former number is greater than the latter number (YES in S50) and advances the processing to S14 otherwise (NO in S50).

The restriction unit 440 may instead determine whether the ratio between the number of persons in the disclosure range who are included in the possible disclosure range and the number of persons who are not included is equal to or greater than a predetermined threshold value.

For example, when the number of persons in the disclosure range of the operation target who are included in the possible disclosure range is greater than the number of persons who are not included, the entire organization included in the disclosure range of the operation target possibly has much job relevance to a belonging organization of the original owner of target information. Even when the disclosure range of the operation target is not included in the possible disclosure range, the information management device 40 according to the fifth example embodiment permits execution of the target operation depending on the ratio between the number of persons in the disclosure range who are included in the possible disclosure range and the number of persons who are not included. Thus, information sharing is accelerated, and job execution is more streamlined.

On the other hand, when the number of persons in the disclosure range of the operation target who are included in the possible disclosure range is less than the number of persons who are not included, the entire organization included in the disclosure range of the operation target possibly does not have much job relevance to the belonging organization of the original owner of the target information. In such a case, the information management device 40 restricts execution of the target operation, and therefore confidentiality is secured.

### Sixth Example Embodiment

Next, a sixth example embodiment will be described. An information management device 50 according to the sixth example embodiment is similar to the information management devices 20 to 40 according to the second to fifth example embodiments, and description thereof is omitted.

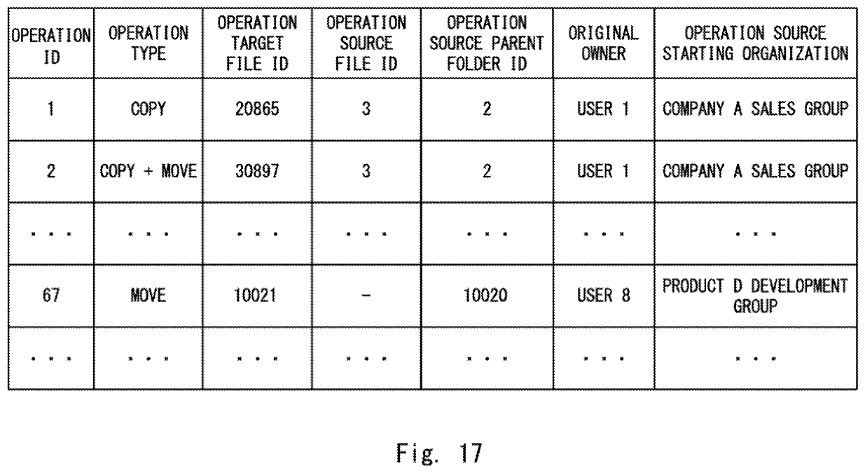

FIG. 17 is a diagram illustrating an example of a data structure of an operation target management log 284 according to the sixth example embodiment. Note that the operation target management log 284 in the information management device 50 according to the sixth example embodiment stores operation source file identification information and operation source parent folder identification information in addition to the information stored in the operation target management log 284 according to the second to fifth example embodiments.

Operation source file identification information is file identification information of an operation source indicating identification information of an operation source path of an executed operation. Operation source file identification information according to the present sixth example embodiment is file identification information of an operation source of an operation possibly being a target operation. When the operation type of an operation possibly being a target operation is “access right change,” the operation source file identification information may be file identification information of a file including target information to which change is specified.

Operation source parent folder identification information indicates identification information of a path to a parent folder of an operation source file. As an example, each of operation source file identification information and operation source parent folder identification information may be a number.

Thus, in order to manage operation-related attribute information including operation source file identification information and operation source parent folder identification information, the information management device 50 can acquire a list of copied files associated with the operation source file as needed. For example, when an administrator or the like deletes an operation source file, the information management device 50 can check with the administrator or the like whether to similarly delete a copy file. Thus, convenience of information management is improved.

Operation source parent folder identification information may be omitted in the operation target management log 284.

### Seventh Example Embodiment

Next, a seventh example embodiment will be described. An information management device 60 according to the seventh example embodiment is similar to the information management devices 30 and 40 according to the fourth and fifth example embodiments, and description thereof is omitted.

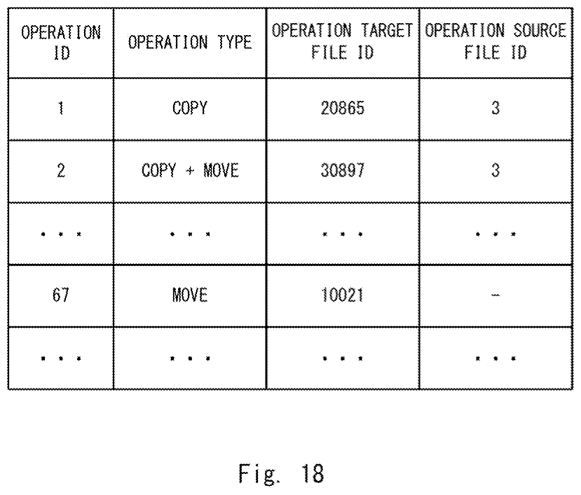

FIG. 18 is a diagram illustrating an example of a data structure of an operation target management log 284 according to the seventh example embodiment. The operation target management log 284 according to the seventh example embodiment stores operation source file identification information in place of original owner information and operation source starting organization information stored in the operation target management log 284 according to the fourth and fifth example embodiments.

Therefore, even when original owner information or operation source starting organization information thereof is changed due to change in a disclosure range of a file including original job-related information, organizational restructuring, or the like, the information management device 60 does not need to modify the operation target management log 284. Thus, convenience of information management is improved.

For example, when a possible disclosure range changes due to change in upper-limit disclosed layer information of a file including original job-related information, a file with operation target file identification information in the operation target management log 284 may not be included in the possible disclosure range. Further, a disclosure range of a file including original job-related information may change, and a file with operation target file identification information in the operation target management log 284 may not be included in the possible disclosure range. However, even in these cases, the information management device 60 can easily perform automatic erasure of files not included in a new possible disclosure range by using the operation target management log 284, checking with an administrator whether to erase the files by displaying a list of the files, and the like. Thus, convenience of information management is further improved.

In this case, a specification unit 320 in the information management device 60 acquires operation source file identification information from the operation target management log 284 instead of performing S22 described in FIG. 9. Then, the specification unit 320 may refer to a management table 281 and acquire original owner information with an owner associated with file identification information related to the operation source file identification information as an original owner. Then, the specification unit 320 may advance the processing to S23.

Further, a restriction unit 240 in the information management device 60 may restrict execution of a target operation in S14 described in FIG. 7 in a case of a target operation being moving of a file on a file path stored in an upper-limit disclosed layer table 385 in addition to a case of a disclosure range not being included in a possible disclosure range. Then, the restriction unit 240 ends the processing.

While the detection unit 210 is assumed to be included in each of the information management devices 20 to 60 according to the second to seventh example embodiments, the detection unit 210 may be included in the user terminal 6 instead. At this time, in response to detecting a target operation, the detection unit 210 in the user terminal 6 may transmit target information, attribute information related to the target operation, and the like to one of the information management devices 20 to 60.

When a target operation is access right change, each of the information management devices 20 to 60 may automatically give a new access right to a path to target information in such a way that a disclosure range is included in a possible disclosure range, in response to restricting execution of the target operation.

While the present example embodiment has been described above, an original owner may be read as an original generator in the descriptions of the second to seventh example embodiments. An original generator may be a generator of a file including original job-related information. In this case, an owner may be read as a generator in FIG. 3.

Further, a file may be read as a folder in the descriptions of the second to seventh example embodiments.

The computer in each of the aforementioned first to seventh example embodiments is configured with a computer system including a personal computer, a word processor, and the like. However, without being limited to the above, the computer may be configured with a server on a local area network (LAN), a host of computer (personal computer) communications, a computer system connected on the Internet, or the like. Further, the computer may be configured with an entire network by distributing the functions across pieces of equipment on the network.

While the present disclosure has been described as a hardware configuration in the aforementioned first to seventh example embodiments, the present disclosure is not limited to the above. The present disclosure may be provide various types of processing such as the aforementioned acquisition processing, detection processing, possible disclosure range specification processing, operation restriction processing, and update processing by causing a processor 1010 to be described later to execute a computer program.

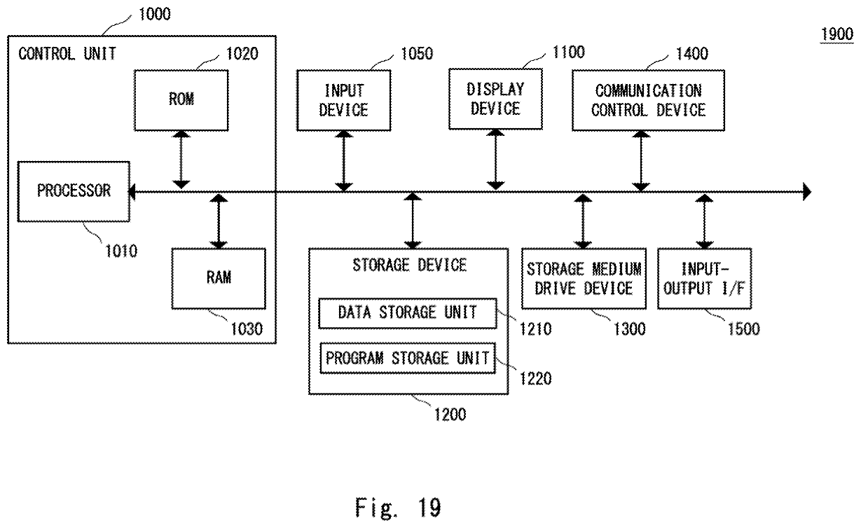

FIG. 19 is a schematic configuration diagram of a computer 1900 according to the present example embodiment.

FIG. 19 is an example of a schematic configuration diagram of the computer 1900 according to the first to seventh example embodiments. As illustrated in FIG. 19, the computer 1900 includes a control unit 1000 for controlling the entire system. The control unit 1000 is connected to an input device 1050, a storage device 1200, a storage medium drive device 1300, a communication control device 1400, and an input-output I/F 1500 through a bus line such as a data bus.

The control unit 1000 includes the processor 1010, a ROM 1020, and a RAM 1030.

The processor 1010 performs various types of information processing and control in accordance with programs stored in various storage units such as the ROM 1020 and the storage device 1200.

The ROM 1020 is a read only memory in which various programs and data for the processor 1010 to perform various types of control and computation are previously stored.

The RAM 1030 is a random access memory used as a working memory by the processor 1010. Various areas for performing various types of processing according to the first to seventh example embodiments can be secured in the RAM 1030.

Examples of the input device 1050 include input devices accepting input from a user, such as a keyboard, a mouse and a touch panel. For example, various keys such as numeric keys, function keys for executing various functions, and cursor keys are placed on the keyboard. The mouse is a pointing device and is an input device for specifying a function by clicking a related key or icon displayed on a display device 1100. The touch panel is input equipment placed on the surface of the display device 1100, specifies a touch position of a user, the position being related to one of various operation keys displayed on a screen of the display device 1100, and accepts input of an operation key displayed according to the touch position.

For example, a CRT or a liquid crystal display is used as the display device 1100. The display device displays an input result by the keyboard or the mouse and displays finally retrieved image information. Further, the display device 1100 displays images of operation keys for performing various required operations from the touch panel, based on various functions of the computer.

The storage device 1200 is configured with a readable-writable storage medium and a drive device for reading and writing various types of information such as a program and data from and into the storage medium.

While a hard disk or the like is mainly used as a storage medium used in the storage device 1200, a non-transitory computer-readable medium used in the storage medium drive device 1300 to be described later may also be used.

The storage device 1200 includes a data storage unit 1210, a program storage unit 1220, and other unillustrated storage units (such as a storage unit for backing up a program, data, and the like stored in the storage device 1200). The program storage unit 1220 stores programs for providing various types of processing according to the first to seventh example embodiments. The data storage unit 1210 stores various types of data in various databases according to the first to seventh example embodiments.

The storage medium drive device 1300 is a drive device for the processor 1010 to read data including a computer program and a document, and the like from an external storage medium.

An external storage medium refers to a non-transitory computer-readable medium on which a computer program, data, and the like are stored. Non-transitory computer-readable media include various types of tangible storage media. Examples of a non-transitory computer-readable medium include magnetic storage media (such as a flexible disk, a magnetic tape, and a hard disk drive), magneto-optical storage media (such as a magneto-optical disk), a CD-read only memory (ROM) a CD-R, a CD-R/W, semiconductor memories [such as a mask ROM, a programmable ROM (PROM), an erasable PROM (EPROM), a flash ROM, and a random access memory (RAM)]. Further, various programs may be supplied to the computer by various types of transitory computer-readable media. Examples of a transitory computer-readable medium include an electric signal, an optical signal, and an electromagnetic wave. A transitory computer-readable medium can supply various programs to the computer through a wired communication channel such as an electric cable or an optical fiber, or a wireless communication channel, and the storage medium drive device 1300.

Specifically, in the computer 1900, the processor 1010 in the control unit 1000 reads various programs from an external storage medium set on the storage medium drive device 1300 and stores the programs into the units in the storage device 1200.

Then, when the computer 1900 executes various types of processing, a relevant program is read into the RAM 1030 from the storage device 1200, and the program is executed. Note that the computer 1900 may directly read a program into the RAM 1030 from an external storage medium by the storage medium drive device 1300 instead of from the storage device 1200 and execute the program. Further, depending on the computer, various programs and the like may be previously stored in the ROM 1020 and be executed by the processor 1010. Furthermore, the computer 1900 may download various programs and data from another storage medium through the communication control device 1400 and execute the programs.

The communication control device 1400 is a control device for connecting the computer 1900 to various types of external electronic equipment such as another personal computer and another word processor through a network. The communication control device 1400 allows the various types of external electronic equipment to access the computer 1900.

The input-output I/F 1500 is an interface for connecting various input-output devices through a parallel port, a serial port, a keyboard port, a mouse port, and the like.

A central processing unit (CPU), a graphics processing unit (GPU), a field-programmable gate array (FPGA) a digital signal processor (DSP), an application specific integrated circuit (ASIC), or the like may be used as the processor 1010.

Processing execution orders in the system and the method described in the claims, the description, and the drawings do not particularly specify “prior to,” “in advance,” and so forth, and sets of processing may be provided in any order unless an output of previous processing is used by subsequent processing. Even when an operation flow is described by using “first,” “next,” and so forth for convenience in the claims, the description, and the drawings, the description does not mean that execution in this order is essential.

While the present disclosure has been described above with reference to the example embodiments, the present disclosure is not limited to the aforementioned example embodiments. Various changes and modifications that may be understood by a person skilled in the art may be made to the configurations and details of the present disclosure, within the scope of the present invention.

### REFERENCE SIGNS LIST

1, 2 INFORMATION MANAGEMENT SYSTEM
4 FILE SERVER
5 ORGANIZATION USER MANAGEMENT DEVICE
6 USER TERMINAL
8 NETWORK
10, 20, 30, 40, 50, 60 INFORMATION MANAGEMENT DEVICE
100, 200, 300 ACQUISITION UNIT
120, 220, 320 SPECIFICATION UNIT
140, 240, 440 RESTRICTION UNIT
210 DETECTION UNIT
260 UPDATE UNIT
280, 380 DATABASE
281 MANAGEMENT TABLE
282 DISCLOSURE RANGE TABLE
283 ORGANIZATIONAL LAYER TABLE
284 OPERATION TARGET MANAGEMENT LOG
385 UPPER-LIMIT DISCLOSED LAYER TABLE
1000 CONTROL UNIT
1010 PROCESSOR
1020 ROM
1030 RAM
1050 INPUT DEVICE
1100 DISPLAY DEVICE
1200 STORAGE DEVICE
1210 DATA STORAGE UNIT
1220 PROGRAM STORAGE UNIT
1300 STORAGE MEDIUM DRIVE DEVICE
1400 COMMUNICATION CONTROL DEVICE
1500 INPUT-OUTPUT I/F
1900 COMPUTER

What is claimed is:

1. An information management device comprising:
at least one memory storing instructions, and
at least one processor configured to execute the instructions to;
acquire belonging organization information indicating a belonging organization of an original owner or an original generator of target information;
in response to receiving a request for an operation on the target information, specify, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and
restrict execution of the operation when at least part of a disclosure range of an operation target path after the operation is not included in the possible disclosure range.

2. The information management device according to claim 1, wherein the at least one processor is to specify the possible disclosure range of the target information or the copy, based on an organizational layer of the belonging organization.

3. the information management device according to claim 2, wherein
the at least one processor is to specify an organization in a direct line of the belonging organization with the belonging organization as a starting point, and
the possible disclosure range does not include an organization not in a direct line of the belonging organization.

4. The information management device according to claim 2, wherein
the at least one processor is to;
acquire upper-limit disclosed layer information indicating an upper-limit disclosed layer indicating an organizational layer being an upper limit of the possible disclosure range, and
specify the possible disclosure range of the target information or the copy, based on an organizational layer of the belonging organization and the upper-limit disclosed layer.

5. The information management device according to claim 2, further comprising an operation target management log configured to store identification information of an operation target path, and the original owner or the original generator of the target information being an operation source in association with each other, and wherein,
the at least one processor is to, when, in response to execution of an target operation, identification information of an operation source path of the target operation matches at least one piece of identification information of the operation target path stored in the operation target management log, associate the original owner or the original generator of the target information associated with matching identification information of the operation target path with identification information of an operation target path of the target operation in the operation target management log.

6. The information management device according to claim 1, wherein the at least one processor is to permit execution of the operation when, in one or more organizations belonging to the disclosure range of an operation target path after the operation, the number of one or more persons in an organization included in the possible disclosure range is greater than the number of one or more persons in an organization not included in the possible disclosure range.

7. An information management system comprising:
a file server comprising at least one memory storing target information of an operation target;
a user terminal comprising:
at least one memory storing instructions, and
at least one processor configured to execute the instructions to specify an operation;
an organization user management device comprising at least one memory storing a user and a belonging organization of the user in association with each other; and
an information management device comprising:
at least one memory storing instructions, and
at least one processor configured to execute the instructions to;
acquire belonging organization information indicating a belonging organization of an original owner or an original generator of the target information;
in response to receiving a request for an operation on the target information, specify, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and
restrict execution of the operation when at least part of a disclosure range of an operation target path after the operation is not included in the possible disclosure range.

8. The information management system according to claim 7, wherein the at least one processor of the information management device is to specify the possible disclosure range of the target information or the copy, based on an organizational layer of the belonging organization.

9. An information management method comprising:
acquiring belonging organization information indicating a belonging organization of an original owner or an original generator of target information;
in response to receiving a request for an operation on the target information, specifying, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and
restricting execution of the operation when at least part of a disclosure range of an operation target path after the operation is not included in the possible disclosure range.

10. A non-transitory computer-readable medium having an information management program stored thereon, the information management program causing a computer to:
acquire belonging organization information indicating a belonging organization of an original owner or an original generator of target information;
specify, in response to receiving a request for an operation on the target information, based on job relevance to the belonging organization, a possible disclosure range indicating an organization group to which the target information or a copy of the target information is possibly disclosed, the operation being accompanied by change of a disclosure range of the target information or the copy, the disclosure range being set to a path to the target information or the copy; and
restrict execution of the operation when at least part of a disclosure range of an operation target path after the operation is not included in the possible disclosure range.
